(19) United States
(12) Patent Application Publication
(10) Pub. No.: US 2014/0156395 A1
(43) Pub. Date: Jun. 5, 2014

(54) SHIFTING MARKETING MESSAGING ACCORDING TO CUSTOMER LIFESTYLE CHANGES

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/691,619

(22) Filed: Nov. 30, 2012

(51) Int. Cl. G06Q 30/02

(52) U.S. Cl. CPC G06Q 30/0255
USPC 705/14.53

(57) ABSTRACT

A process and method for tailoring marketing messaging to retail customers is disclosed. Embodiments of the present disclosure comprise a system adapted to identify significant lifestyle changes in a customer's life by recording and analyzing the customer's purchasing behavior and to adjust marketing messaging directed at the customer in accordance with the identified lifestyle change. The marketing messaging system may search a customer's purchase history for known correlations between shopping behavior and demographic, socioeconomic, and other similar classifications of retail customers. By identifying changes in shopping patterns, the system of the present disclosure can tailor marketing messaging for the recipient consumer, thereby increasing marketing effectiveness.

### BACKGROUND

Generally, a retail establishment may increase the effectiveness of its marketing efforts by directing tailored marketing at customers. Marketing activities may be tailored specifically for a customer based on the customer's socioeconomic status, demographic characteristics, or other such classifications.

Typical consumers may exhibit purchasing behavior that follows trends that, over time, portray a reasonably-accurate representation of the consumer's lifestyle, socioeconomic status, and other data pertinent to the consumers. However, it may be costly, inefficient, and troublesome to gather customer-related demographic, socioeconomic, and like data using traditional means.

What is needed, therefore, is a system for analyzing a customer's purchasing trends to ascertain the customer's socioeconomic status, demographic characteristics, or like classifications and using the results of that analysis to direct a marketing messaging strategy that is tailored for the customer in light of the customer's socioeconomic status, demographic characteristics, or like classification.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a schematic block diagram of a marketing messaging system according to one embodiment;

FIG. 2 is a flowchart illustrating an exemplary method of tailoring marketing messaging for a customer; and

FIGS. 3A-3B are illustrations of graphical user interfaces displayed on a mobile computing device, presenting marketing messaging for a customer in accordance with various embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Embodiments of the present disclosure comprise methods and systems that allow a retailer to: make a record of purchase habits of retail customers, analyze those purchase habits, identify any significant changes or events in the customers' lives, and present a marketing messaging strategy that is tailored for the customer in response to the identified changes. Tracking customer purchasing habits may be accomplished by assigning a unique identification number to each customer and inputting the unique identification number at each retail transaction completed. By customizing marketing messages for a customer, the retailer may enhance the effectiveness of its marketing efforts and increase the likelihood that the customer will shop more at the retailer's stores. The customized marketing messages for a customer may be presented via an installed application on the customer's mobile computing device, commonly known as a smartphone app. Alternatively, marketing messaging may be presented to a customer on a webpage, in printed marketing materials, electronic mail, or the like.

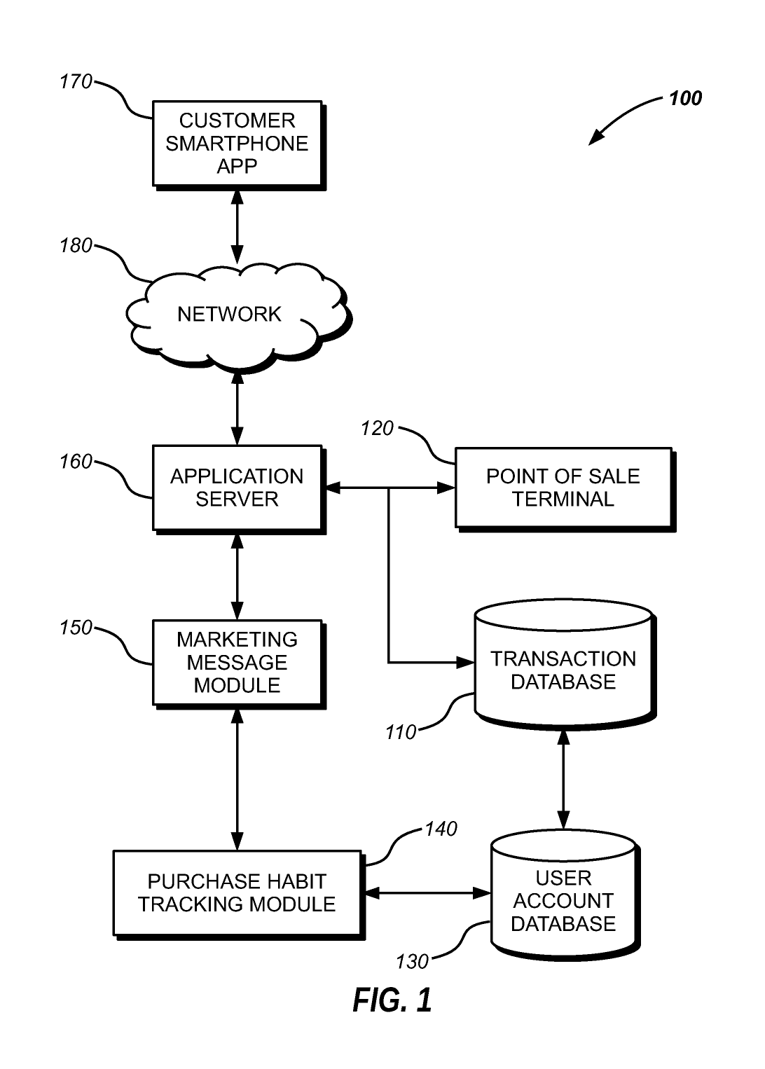

With reference to FIG. 1, marketing messaging system 100 comprises transaction database 110 for maintaining a record of purchases made by retail customers. The transaction database 110 may associate certain retail purchase transactions with a customer. In particular, a transaction is linked within transaction database 110 to a unique customer identification number (“CIN”). Such transactions may be linked to customers at the time of sale by the customer or a retail sales associate inputting identifying indicia of the customer into a point of sale (“POS”) terminal 120. Identifying indicia that may be entered into the POS terminal 120 at the time of transaction may include the CIN, the customer's name, the customer's telephone number, the customer's credit or debit card number, or like identifying indicia. In alternative embodiments, customers carry a keychain tag or card that has identifying indicia printed or encoded thereon, such as a barcode of the CIN, an RFID tag carrying the CIN, membership card, payment card, or the like. The tag or card may be input at the POS terminal 120 by a reader. In alternative embodiments, the identity of a customer is ascertained through mobile app pairing techniques, communication via audible or inaudible sounds between the POS 120 and customer smartphone, geo-fencing via a mobile app, facial recognition, biometric identification, or the like.

In alternative embodiments, transactions may be input to transaction database 110 at any time after completion of the transaction by inputting a code on a receipt for that transaction. The code could be represented by a hyperlink, a unique numerical code, a one- or two-dimensional barcode on the receipt, or other means. In embodiments, the code for that transaction may be input by a customer scanning the receipt, or particularly the barcode thereon, with a smartphone. In alternate embodiments, the code on the receipt is submitted on a webpage by a customer. Upon inputting the code, application server 160 transmits the customer's identifying indicia with a transaction identifier to the transaction database 110, which associates the transaction with that customer.

Upon input of a customer's CIN or other identifying indicia during a transaction, data related to that transaction is transmitted to transaction database 110. The data may include product(s) purchased, including universal product codes (“UPC”) or other product codes, service(s) purchased, the price paid for each product or service, the CIN, the date and time, and other relevant information about the transaction. Such data is aggregated and stored in transaction database 110. User account database 130 stores transaction data, demographic data, or other relevant information for one or more customers. Such data may be aggregated from multiple point of sale terminals 120 through transaction database 110 and may represent a collection of most or all data that the retailer has about the customer.

User account database 130 is adapted to provide transaction history data to purchase habit tracking module 140. Purchase habit tracking module 140 is adapted to receive user data from user account database 130 and analyze said data to detect purchasing habits, trends, and patterns. As described in more detail herein, purchase habit tracking module 140 can identify a customer's lifestyle changes by detecting changes in customer's purchasing habits. Lifestyle changes may include occurrences that alter the customer's demographic, economic, domestic, employment, educational, or other socioeconomic status indicators. Examples of lifestyle changes may include, but are not limited to: graduation from secondary education (commonly known as high school) or higher education, getting a new job, losing a job, receiving a promotion and/or pay increase, getting married, birth or adoption of a child, death of a family member, and getting divorced. As explained in further detail herein, by observing changes in purchasing habits, purchase habit tracking module 140 is able to deduce that the customer has undergone a lifestyle change. Purchase habit tracking module 140 is adapted to transmit an alert to marketing message module 150. The alert may indicate merely the fact that the customer experienced a lifestyle change or may provide information as to the type or nature of the detected lifestyle change.

Marketing message module 150 is adapted to receive alerts regarding a customer's lifestyle change from purchase habit tracking module 140 and determine a course of action to increase marketing effectiveness with respect to the customer. As one of ordinary skill in the art having the benefit of this disclosure would understand, knowledge about the demographic status of a customer can inform marketing efforts and help a retailer to more effectively target the customer with marketing schemes that may be more favorably received by the customer or otherwise carry a stronger impact to the customer. Accordingly, marketing message module 150 can direct a tailored marketing scheme for the customer based on any lifestyle change alerts received from purchase habit tracking module 140. Instructions or specific details regarding the tailored marketing scheme may be transmitted to application server 160, which may provide specific formatting, graphical user interfaces, and messaging to the customer through customer's smartphone app 170 as directed by marketing message module 150. Computer-readable instructions regarding the formatting, marketing assets, graphical user interfaces, messaging, and data may be transmitted from application server 160 to customer smartphone app 170 through network 180. As used herein, the term “network” can refer to any communication network including, but not limited to: a wireless network, a cellular network, an intranet, the Internet, or combinations thereof.

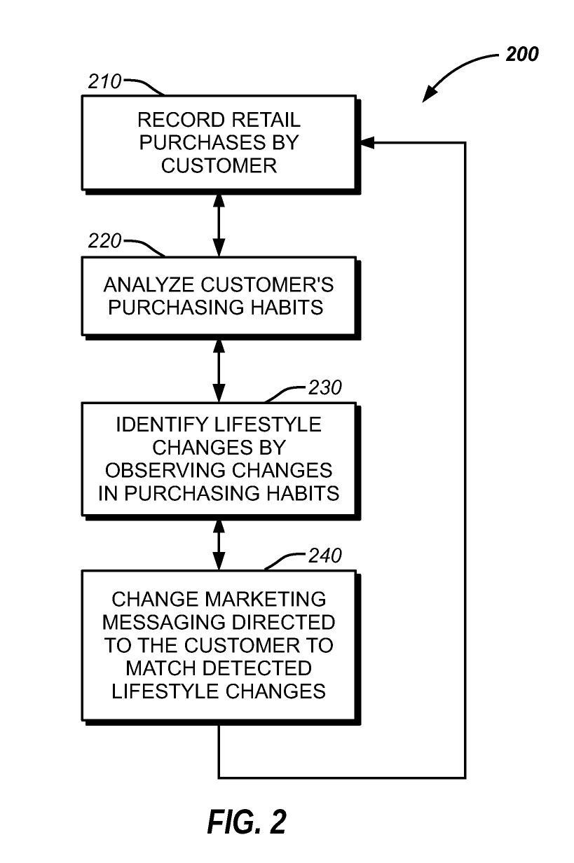

In operation, marketing messaging system 100 is adapted to identify significant changes in a customer's life, especially those that may indicate how the customer may respond to various marketing schemes, and to adjust the marketing messaging for that customer. Specifically, such marketing messaging may be presented to the customer on the customer's smartphone app 170. Referring now to FIG. 2, embodiments of the present disclosure comprise method 200. At operation 210, the retail purchases made by a customer are recorded in transaction database 110. Purchases may be aggregated from in-store purchases and purchases made on the retailer's website. The transaction database 110 may record data including the product(s) or type of product(s) purchased, the types of services purchased, the time and date of purchase, the cost of each item purchased, the store in which the transaction was completed, the geographic location of the transaction, if any manufacturer or retail coupons were presented by the customer, the customer's method of payment, and any other relevant data. Collected transaction data relevant to the customer is aggregated in user account database 130 with any relevant additional information about that customer.

Purchase habit tracking module 140 is adapted to query user account database 130 to receive and analyze user data. At operation 220, purchase habit tracking module 140 analyzes the customer's purchasing patterns. At operation 230, purchase habit tracking module 140 identifies trends and recognize changes in purchasing habits. Such changes may signal that the customer has recently undergone a change in lifestyle. Purchase habit tracking module 140 can analyze the type of product or service sold to the customer as described in further detail below to generate assumptions regarding the customer's demographic, socioeconomic, or like classification. Several additional examples are presented below.

In one case, a customer may regularly purchase a relatively inexpensive food item (for example, ramen noodles). If, after a passage of time, that customer began purchasing less of that inexpensive item and began purchasing higher cost items instead (for example, organic foods or relatively expensive cuts of meat), purchase habit tracking module 140 may ascertain that the customer has recently received a pay increase or the like. Purchase habit tracking module 140 may analyze the customer's retail transactions to identify any trends. If the customer's overall transaction dollar spending exhibits an upward or downward trend, purchase habit tracking module 140 may ascertain that the customer has recently received a corresponding pay increase or decrease. In another case, a customer may begin to regularly purchase relatively inexpensive food items after having established a pattern of purchasing higher-cost food items. In this case, purchase habit tracking module 140 may ascertain that the customer has recently experienced a loss or reduction of disposable income.

In another case, a customer may regularly shop at a particular retail store branch. If the customer began regularly shopping at a different store branch, purchase habit tracking module 140 may ascertain that the customer has moved into a new residence. If the new store is in a more affluent area with a relatively higher cost of living, purchase habit tracking module 140 may further ascertain that the customer has experienced an increase in disposable income.

In another case, a customer may begin to establish a pattern of purchasing items that a homeowner would typically purchase, such as a lawnmower, gardening supplies, house paint, and the like. In this case, purchase habit tracking module 140 may ascertain that the customer has recently become a homeowner. In another case, a customer may begin regularly purchasing diapers, baby wipes, baby formula, pacifiers, infant clothing, or other products typically associated with newborn babies. Purchase habit tracking module 140 may ascertain that the customer has recently become a parent or caretaker of a baby.

In another case, a customer may have exhibited a purchasing habit that is correlated with a specific gender. For example, the customer may have repeatedly purchased deodorant and shaving razors branded for men. If the customer began additionally regularly purchasing products typically marketed to women, such as certain jewelry items or hygiene products, purchase habit tracking module 140 may ascertain that the customer has recently entered into a relationship. Alternatively, if the customer had previously established purchasing habits that included products marketed to both men and women, and subsequently created a new pattern of only purchasing products marketed to women, tracking module 140 may ascertain that the customer has recently become single.

In another case, a customer may have hired a different accountant than the customer previously engaged. If the different accountant has offices located in a city that is geographically remote from where the customer's previous accountant worked, purchase habit tracking module 140 may ascertain that the customer has recently moved to the new city. It is to be understood that the foregoing examples are provided for illustration of possible applications of embodiments of the present disclosure and are not to be interpreted in a limiting sense.

Purchase habit tracking module 140 may be configured to employ machine-learning techniques known in the art to optimize the identification of significant life events. In embodiments of the present disclosure, socioeconomic, demographic, and like data regarding a test group of customers may be acquired directly from the customers, for example through voluntary surveys administered to the customers. Purchase histories of those customers may then be analyzed and patterns identified and correlated to specific lifestyle changes. By identifying purchasing patterns that have higher degrees of correlation to specific demographic and socioeconomic classifications of the customers, purchase habit tracking module 140 can be adapted to look for such identified patterns or behaviors and correlate the patterns with the known socioeconomic or demographic condition linked to that pattern or behavior.

Upon determining that the customer has undergone a lifestyle change as described above, purchase habit tracking module 140 transmits an alert to marketing message module 150. At operation 240, marketing message module 150 modifies the marketing messaging presented to the customer to take advantage of the specific data regarding the customer's demographic, socioeconomic, or like characteristics. Examples of how the marketing messaging may be tailored for the customer include emphasizing certain slogans, altering graphical elements in marketing materials, or by other means known in the art. For example, if a customer has recently received a pay raise, marketing message module 150 may alter the marketing messaging from an emphasis of the retailer's low prices to a focus of high-end products sold by the retailer. Likewise, the marketing messaging may be tailored by changing the aesthetic nature of the marketing material to appear more upscale in a way that may appeal to a higher-income demographic. As another example, if a customer has recently become a parent, the marketing message module 150 may provide market messaging tailored to new parents and emphasize marketing messages that may appeal to new parents. Generally, marketing messaging may comprise aesthetic changes to the underlying design scheme in ways that help the customer feel more comfortable using the smartphone app 170 and more likely to empathize with the presentation thereof.

Marketing messaging may be provided in connection with customers' use of smartphone app 170, such as browsing product descriptions, viewing electronic receipts of retail transactions, or viewing other media from the retailer. Operations of method 200 may be accomplished dynamically, wherein retail transactions involving a specific customer are analyzed as they are completed, or in batches by reviewing multiple transactions involving that customer at one time.

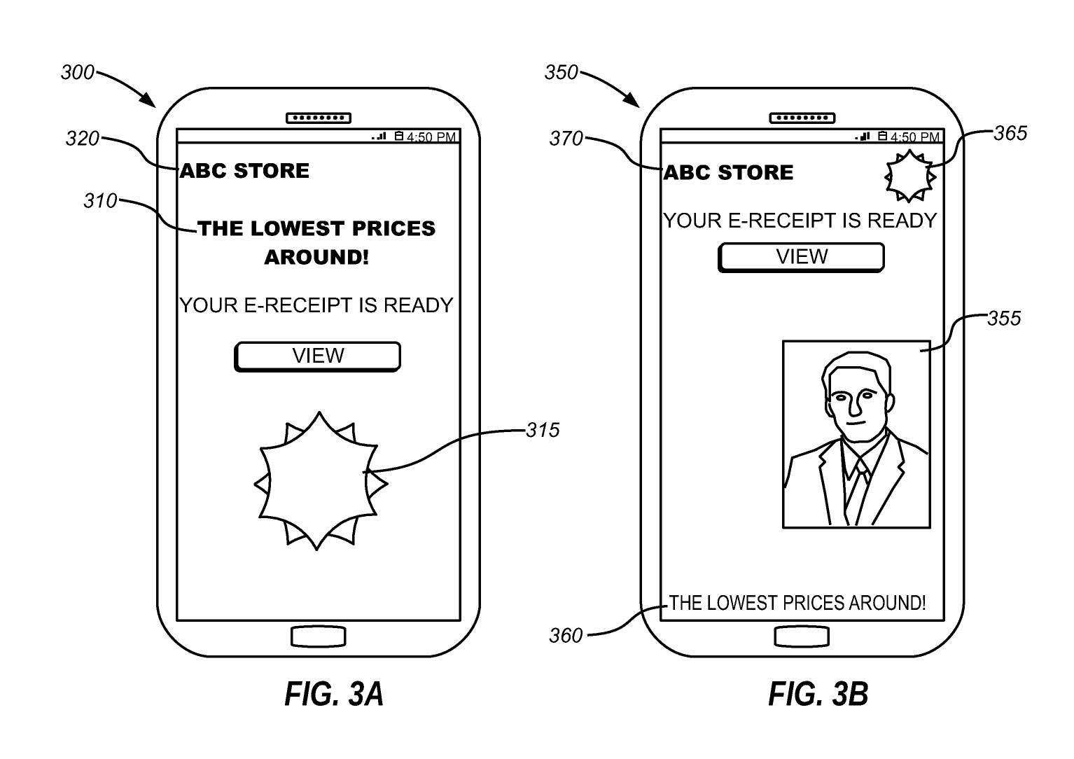

Referring now to FIG. 3A, in one embodiment, marketing messaging presented to the customer on smartphone 300 may comprise slogan 310 and large logo 315. As depicted in FIG. 3A, logo 310 is displayed in a conspicuous position directly beneath the store name 320. Further, large logo 315 is displayed on-screen. The graphical elements and layout on the display of smartphone 300 may be presented according to predetermined design parameters associated with a customer's socioeconomic status. In the exemplary embodiment depicted in FIG. 3A, purchase habit tracking module 140 may have ascertained that the customer fell in a low-income socioeconomic stratum. As a result, marketing message module 150 emphasized slogan 310, thereby highlighting the retailer's low prices.

Referring now to FIG. 3B, a customer may have exhibited shopping patterns that demonstrate a salary increase. Purchase habit tracking module 140 may have ascertained that this customer now falls in a high-income socioeconomic group. Accordingly, marketing message module 150 presented the graphical elements and layout shown on the display of smartphone 350. Stock photography 355 may be chosen as being effective for that demographic, as well as a de-emphasis on low prices as reflected in the less-conspicuous slogan 360 in a less prominent screen location. Likewise, logo 365 is presented in a smaller size displayed at the top of the screen with store name 370. It is to be understood that various graphical elements, layouts, color themes, stock photography, slogan placement and/or emphasis level, and the like may be used to provide marketing messaging according to the analysis of purchase habit tracking module 140. These design considerations may be made to increase the effectiveness of marketing messaging to specific demographic, socioeconomic, or other classifications of customers.

In embodiments of the present disclosure, purchase habit tracking module 140 is adapted to select one best-fit class into which a customer may be categorized. The selection may be made from a group of potential classifications, such as four classifications found in an embodiment: new mother, business person, new relationship, and new homeowner. In this embodiment, each of the foregoing classifications is associated with a set of media assets comprising stock photographs, logos, color schemes, layouts, and the like. When one of the classifications is detected by purchase habit tracking module 140, the corresponding set of assets is selected by marketing message module 150 and thereafter displayed on customer's smartphone app 170 for electronic receipts, in conjunction with user menus, while the customer is browsing the retailer's website, in e-mails from the retailer to the customer, or the like. In alternative embodiments, any number of classifications may be included in the analysis. It is conceivable that a customer may simultaneously fall under multiple demographic classifications. In such cases, the marketing message module 150 may be configured to provide a combination of the assets respectively associated with each demographic group. Alternatively, marketing message module 150 may be configured to associate a distinct asset group with such mixed classifications. Customer smartphone app 170 may store the various media assets locally on the customer's mobile device. Alternatively, the assets are stored remotely and transmitted to smartphone app 170 through network 180, as appropriate.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A computer-implemented method of tailoring marketing messaging for a customer, comprising:
analyzing purchase trends of the customer electronically using a software module configured to generate assumptions based on a user's purchase transactions;
identifying changes in the purchase trends that signal a customer lifestyle change;
selecting a marketing messaging scheme to match the customer lifestyle change; and
transmitting computer-readable instructions to a mobile computing device of the customer, wherein the computer-readable instructions correspond to the marketing messaging scheme.

2. The method of claim 1, further comprising electronically recording transactions between a retailer and the customer.

3. The method of claim 1, wherein analyzing purchase trends of the customer electronically using a software module configured to generate assumptions based on a user's purchase transactions comprises analyzing products purchased by the customer.

4. The method of claim 1, wherein analyzing purchase trends of the customer electronically using a software module configured to generate assumptions based on a user's purchase transactions comprises analyzing services purchased by the customer.

5. The method of claim 1, wherein selecting a marketing messaging scheme to match the customer lifestyle change comprises selecting one or more marketing assets to display on the mobile computing device.

6. The method of claim 5, wherein the one or more marketing assets comprise an image.

7. The method of claim 5, wherein the one or more marketing assets comprise a slogan.

8. The method of claim 5, wherein the one or more marketing assets comprise a page layout.

9. The method of claim 1, wherein identifying changes in the purchase trends that signal a customer lifestyle change comprises analyzing spending trends of the customer.

10. The method of claim 1, further comprising:
receiving a survey response from a surveyed customer;
analyzing a shopping history of the surveyed customer;
analyzing the survey response; and
identifying correlations between the shopping history and the survey response.

11. The method of claim 1, further comprising selectively emphasizing a marketing slogan in response to the customer lifestyle change.

12. The method of claim 1, wherein recording transactions between a retailer and the customer comprises recording at least one of a purchase price, a product identification, a transaction time, a transaction date, or a transaction payment method.

13. The method of claim 1, wherein the customer lifestyle change comprises one selected from the group consisting of: graduation from secondary education, graduation from higher education, obtaining employment, losing employment, receiving a promotion, receiving a pay increase, receiving a pay decrease, getting married, entering into a relationship, birth of a child, adoption of a child, death of a family member, getting divorced, and ending a relationship.

14. A system for tailoring a marketing message for a customer, comprising:
at least one point of sale terminal adapted to receive a customer identification number;
a customer database adapted to record a purchase history of the customer;
a purchase habit tracking module adapted to review the purchase history to identify a detected lifestyle change of the customer;
a marketing message module adapted to selectively tailor marketing messaging for the customer in response to the detected lifestyle change; and
an application server adapted to transmit instructions to the customer related to the marketing messaging, wherein the instructions correspond to the marketing messaging.

15. The system of claim 14, wherein the detected lifestyle change comprises one selected from the group consisting of: graduation from secondary education, graduation from higher education, obtaining employment, losing employment, receiving a promotion, receiving a pay increase, receiving a pay decrease, getting married, entering into a relationship, birth of a child, adoption of a child, death of a family member, getting divorced, and ending a relationship.

16. The system of claim 14, wherein the marketing message module is adapted to selectively emphasize a marketing slogan in response to the detected lifestyle change.

17. The system of claim 14, wherein the marketing message module is adapted to select one or more marketing assets to display on a mobile computing device.

18. The system of claim 17, wherein the one or more marketing assets are selected from the group consisting of an image, a slogan, and a page layout.
